(19) United States
(12) Patent Application Publication
(10) Pub. No.: US 2010/0186547 A1
(43) Pub. Date: Jul. 29, 2010

(54) BICYCLE PEDAL

(76) Inventor: David Linden, Berlin (DE)

Correspondence Address: PATENT CENTRAL LLC;Stephan A. Pendorf, 1401 Hollywood Boulevard, Hollywood, FL, 33020, US

(21) Appl. No.: 12/668,483

(22) PCT Filed: Jul. 12, 2008
(86) PCT No.: PCT/DE08/01152

§ 371 Date: Jan. 11, 2010

(30) Foreign Application Priority Data
Jul. 13, 2007 (DE) 10 2007 034 882.9
Jul. 11, 2008 (DE) 20 2008 009 511.5

(51) Int. Cl. B62M 3/08

(52) U.S. Cl. 74/594.4

(57) ABSTRACT

The invention relates to a bicycle pedal, especially for BMX bikes, which consists of a solid tread plate and a solid mating plate (1, 2) that are identical so that, depending on the position of the pedal, the tread plate (1) can also be the mating plate (2) or vice versa. A spacer (3) is interposed between the tread plate (1) and the mating plate (2) and guarantees the distance between the tread plate and the mating plate (1, 2). Said spacer has a bore (5) receiving a bearing unit (6) for the pedal pin (4), the remaining strip of material (a) between the bore (5) and the external surface of the spacer (3) being almost zero in the area of the tread and mating plate (1, 2) so that the force is transmitted almost directly from the tread plate (1) onto the bearing unit (6). The tread plate and the mating plate (1, 2) are connected by at least two connecting elements (9) which are arranged at both sides of the bearing unit (6).

The invention relates to a bicycle pedal as used in particular with BMX (Bicycle MotoCross) bicycles or mountain bikes.

In contrast to standard pedals, these BMX pedals are larger, more robust, and made of metal (aluminium, magnesium). As a result of these materials, a weight reduction to approx. 320 g per pedal pair is achieved.

In order to provide a better foothold, the pedals have a grip on the tread plate (DE 42 03 777 A1, U.S. Pat. No. 6,647,826 B2) or with more expensive models, are equipped with replaceable steel pins. The pedals are mounted on the pedal axis by BB ball bearings, and with high-quality models, with long-life SB ball bearings.

It is characteristic for the bearing that the pedals comprise a supporting body in which the bearing is achieved, and the tread plates are fitted onto or into this supporting body.

In U.S. Pat. No. 4,345,487, this is achieved by clipping them on, and in U.S. Pat. No. 5,927,155, by screwing on. The supporting body can here also be divided in order to support a bearing sleeve (WO 2007/009258 A1, U.S. Pat. No. 6,647,826 B2). With U.S. Pat. No. 6,647,826 B2, the abrasive tread plate arranged on the supporting body should have a thickness of 0.7 mm.

The disadvantage with these designs is that the mass of the supporting body can only be reduced to a limited degree due to its supporting function for the bearing, and thus the weight reduction for the pedals overall is restricted.

The object of the invention is to achieve a further weight reduction of the pedals, while designing the pedals in a flat manner. This object is attained by means of the features described in patent claim 1; advantageous embodiments are the subject of the subordinate claims.

According to the invention, a bicycle pedal is recommended, in particular for BMX bicycles, which consists of a full-surface tread plate and a full-surface counterplate which are of identical design, so that depending on the position of the pedal, the tread plate can also be a counterplate, and vice-versa, between the tread plate and the counterplate, a spacer is arranged which guarantees the distance between the tread plate and the counterplate, the spacer comprises a drill hole for retaining a bearing unit for the pedal axis, wherein the remaining material bar (a) between the drill hole and the outer surface of the spacer approaches zero in the area of the tread plate and the counterplate, so that the force is transferred almost directly from the tread plate to the bearing unit, and the connection between the tread plate and the counterplate is created by at least two connection elements, which are arranged respectively on both sides of the bearing unit.

According to the principle of the invention, approaching zero means that the height of the spacer is almost the same, or the same as the diameter of the drill hole for the bearing unit.

Thus, a new approach has been selected in technical terms, namely a move away from a supporting body for the pedal bearing and tread plates which are affixed on or in the supporting body.

With the recommended solution, the tread force is transferred directly onto the pedal bearing via the tread plate and the counterplate. The only task of the spacer is to enable the tread plate and the counterplate to be connected at a distance, and to guarantee a fixation of the bearing bush or bearing at the pedal level, i.e. parallel to the tread plate and the counterplate. Here, the spacer can also be part of the bearing itself by having bearing properties.

Due to the arrangement of connection elements between the tread plate and the counterplate in direct proximity to the bearing bush, the affixation of the bearing unit is guaranteed.

The result is that instead of a weight-intensive supporting body, only an extremely light spacer is required, which can in addition be further reduced in weight by means of hollow areas.

A spacer is also recommended which is formed from a solid material in the area of the drill hole for the pedal axis and from an arrangement of the connection elements of the tread plate and the counterplate, and otherwise from bars which affix an edge which runs between the tread plate and the counterplate.

Synthetic materials have been proven to be suitable as materials for the spacer, including fibre-reinforced materials or wood layers. Tests have shown that even polystyrol is sufficient as a material for the spacer.

Preferred materials for the tread plate and the counterplate are stainless steel, aluminium, magnesium or titanium or other light, high-tensile materials, including compound materials or a combination of these.

Since BMX bicycles are known to be subjected to high stress, and that the pedal also sometimes encounters an obstacle at the side, a material should be used for the spacer which cannot be so easily broken off from the edge area of the pedal, and/or the pedal comprises at least one coating which runs at the side of the spacer, which should preferably cover the outer narrow circumference surfaces of the tread plate and the counterplate.

It is also advantageous, as a further embodiment shows, when the outer narrow circumference surfaces of the tread plate and the counterplate are embedded in the spacer.

Alongside the protective function, a coating of this type which runs out can simultaneously be used for advertising purposes.

The bearings which support the pedal on the pedal axis can have different embodiments. The following designs are preferred:
The bearing unit consists of two bearings which are arranged on the pedal axis, which support each other in a bearing bush, wherein the bearing bush is inserted into the drill hole and affixed.
The bearing unit consists of two bearings which are arranged on the pedal axis, of which one bearing is supported in a bearing bush, wherein the bearing bush is inserted into the drill hole and affixed, while the other bearing is directly supported in the drill hole.
The bearing unit consists of at least one tribological pairing between the pedal axis and a bearing sheath which is pushed over the pedal axis, wherein the pedal sheath is inserted into the drill hole and affixed.
The bearing unit consists of a tribological pairing between the pedal axis and a bearing sheath which is pushed over the pedal axis, wherein the bearing sheath is inserted into the drill hole and affixed, and a bearing which is supported in the drill hole.
The bearing sheath is formed from the drill hole in the spacer, so that at least one tribological pairing exists between the pedal axis and the inner wall of the drill hole, and the pedal axis is rotatably affixed in the spacer.

In order to affix the pedal against the pedal axis in the pedal axis direction, a preferred embodiment provides that in a section of the drill hole, the spacer comprises an opening which can be covered by the tread plate and the counterplate, so that the inserted bearing unit can here be affixed using a snap ring or clip.

An embodiment of this type can also consist of the fact that the drill hole for the bearing bush or sheath comprises at least one ring groove-type enlarged section, and the bearing bush or sheath has at least one ring groove-type recess, in such a manner that a snap ring or clip which grips into the groove-type recess simultaneously grips into the groove-type enlarged section and thus prevents the pedal body from being displaced on the pedal axis. The ring groove-type enlarged section of the drill hole for the bearing bush here penetrates the outer surface of the spacer in the area of the material bar (a), so that the snap ring or clip can be inserted into this opening which is created.

With a preferred embodiment, it is furthermore provided that at least one of the tread plate and the counterplate which are connected to each other acts on the snap ring or clip, so that it is affixed with no play in the connection between the bearing bush/bearing sheath and the spacer.

In order to use different bearings depending on the load (roller bearings, slide bearings), it has been shown to be advantageous, also with this pedal bearing, that a pedal axis is used which tapers outwards, i.e. which tapers outwards away from the bicycle. The load-bearing capacity of the pedal axis is not restricted as a result, while at the same time, the overall weight of the pedal axis/pedal is further reduced.

The recommended pedal will now be explained with reference to the drawings, in which:

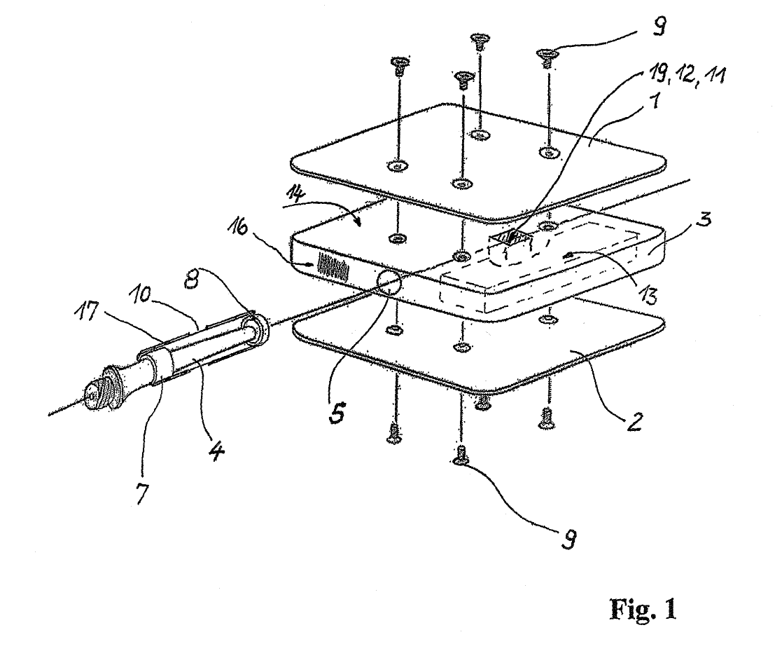

FIG. 1 shows an exposé drawing

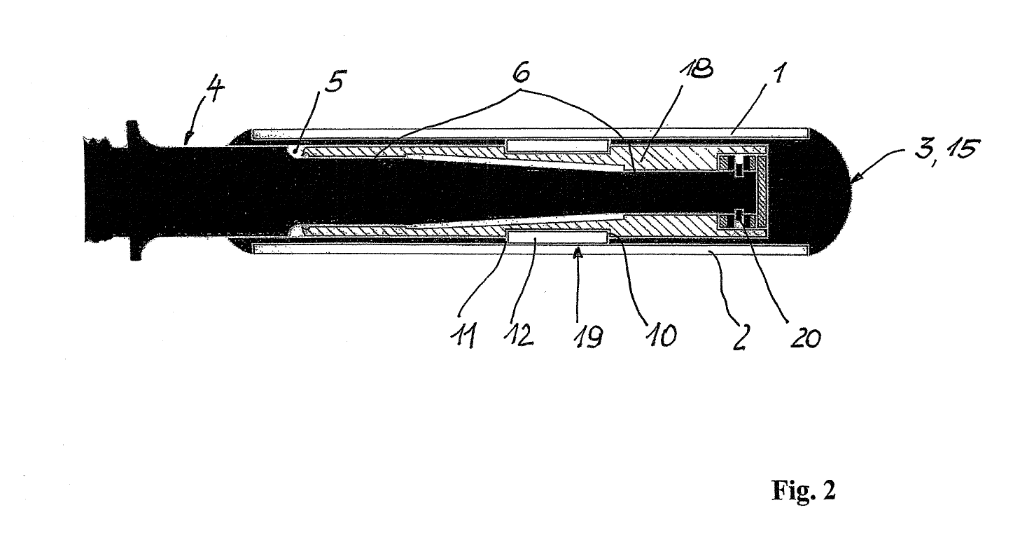

FIG. 2 shows a spacer with bearing bush with pedal axis

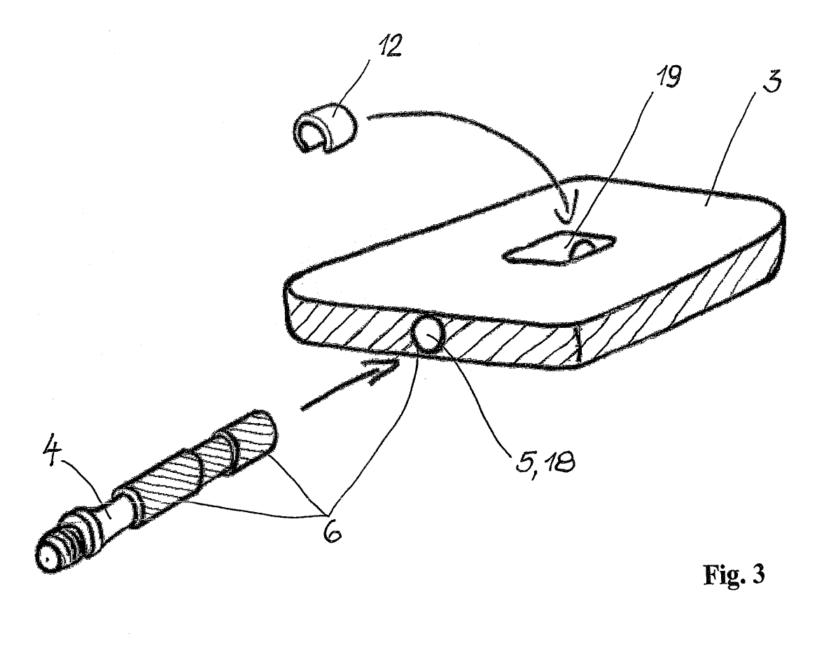

FIG. 3 shows a spacer only with supported pedal axis

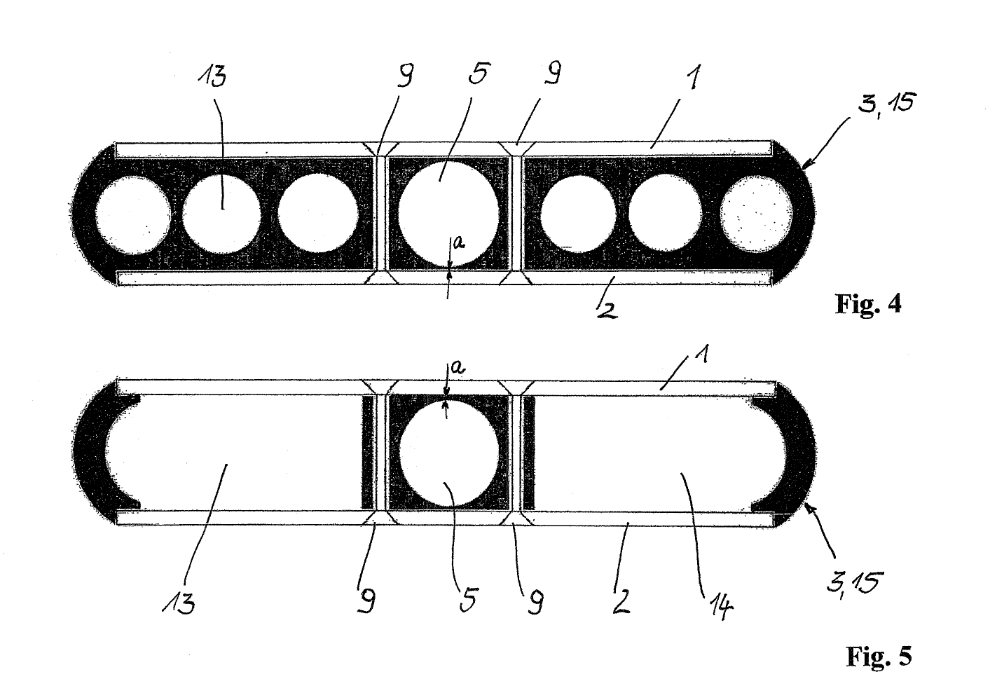

FIG. 4 shows a spacer with bars, and

FIG. 5 shows a spacer with pedal axis seat and edge

FIG. 1 shows in an exposé drawing the basic structure of an embodiment with a bearing unit 6 consisting of a bearing bush 17 for the inside and outside bearing 7, 8.

The spacer 3 is arranged between the tread plate and the counterplate 1, 2. Here, the tread plate and the counterplate 1, 2 are designed in the same manner, so that both can act as a tread plate 1, while the other respectively acts as the counterplate 2.

The tread plate and the counterplate 1, 2 are connected to each other by means of a screw connection with the inclusion of the spacer 3. The screw connection consists of two screw fittings 9 which are respectively on both sides of the drill hole 5 for the bearing bush 17 and in direct proximity to the drill hole 5. In the drill holes for the countersunk head screws 9, one thread bush is arranged respectively, into which the screw fittings 9 grip on both sides.

The remaining material bar (a) between the drill hole 5 and the outer surface of the spacer 3 is minimal in the area of the tread plate and the counterplate 1, 2, so that the force is transferred almost directly from the tread plate 1 to the bearing bush 17.

The pedal axis 4 is supported in the bearing bush 17 using two bearings, the inner bearing 7 and the outer bearing 8. In relation to the bicycle, the outer bearing 8 is a ball bearing and the inner bearing 7 is a slide bearing. The pedal axis 4 tapers between the inner bearing 7 which is designed as a slide bearing and the ball bearing of the outer bearing 8.

The drill hole 5 comprises a ring groove-type enlarged section 11, and the bearing bush 17 has a groove-type recess 10, in such a manner that a snap ring or clip 12 which grips into the groove-type recess 10 simultaneously grips into the groove-type enlarged section 11, and thus, a displacement of the pedal body on the pedal axis 4 is prevented.

The ring groove-type enlarged section 11 of the drill hole 5 for the bearing bush 17 here penetrates the outer surface of the spacer 3 in the area of the material bar (a), so that the snap ring or clip 12 can be inserted into this opening 19 which is created. Naturally, the opening 19 can also be further enlarged.

The spacer 3 comprises hollow areas 13, 14 which are at a distance from the drill hole 5. Its outer form is preferably rhomboid. The outer coating 16 extends over the narrow circumferential surface of the tread plate and the counterplate 1, 2, and also protects these.

FIG. 2 shows a pedal on the pedal axis 4 with a spacer 3 with bearing sheath 18 and tread plate and the counterplate 1, 2. The outer narrow circumferential surfaces of the tread plate and the counterplate 1, 2 are embedded in the spacer 3.

Here, the bearing unit 6 consists of two tribological pairings between the pedal axis 4 and the bearing sheath 18 which is pushed over the pedal axis 4, wherein the bearing sheath 18 is inserted into the drill hole 5 and affixed. The pedal axis 4 tapers between the inner bearing and the outer bearing (tribological pairings with the bearing sheath 18 respectively).

For affixation purposes, the spacer 3 comprises an opening 19 in a section of the drill hole 5 which can be covered by the tread plate and the counterplate 1, 2, so that the inserted bearing unit 6 can here be affixed by means of the snap ring or clip 12. For this purpose, a ring groove-type enlarged section 11 has been incorporated into the drill hole 5, and the bearing sheath 18 has been equipped with a groove-type recess 10, in such a manner that the snap ring or clip 12 which grips into the groove-type recess 10 simultaneously grips into the groove-type enlarged section 11, thus preventing a displacement of the pedal body on the pedal axis 4. The bearing sheath 18 is itself secured on the outer end against displacement on the pedal axis 4 by a snap ring 20.

At least one of the tread plate or counterplate 1, 2 which are connected to each other here acts on the snap ring or clip 12, so that the snap ring or clip 12 is affixed with no play in the connection between the bearing bush 17 and the spacer 3, or the bearing sheath 18 and the spacer 3.

With the embodiment according to FIG. 3, the bearing sheath 18 is formed from the drill hole 5 in the spacer 3, wherein two tribological pairings exist between the pedal axis 4 and the inner wall of the drill hole 5. The pedal axis 4 is rotatably affixed in the spacer 3, wherein here, the clip connection already described is again used.

FIGS. 4 and 5 show embodiments of the spacer 3, namely a spacer 3 shown in FIG. 4 with bars which hold the edge 15, and which consists of a solid material in the area of the drill hole 5 and the arrangement of the connection elements 9, and in FIG. 5, a spacer 3 is shown with pedal axis support and a circumferential edge 15, which is solely connected to the pedal axis support. The outer, narrow circumferential surfaces of the tread plate and the counterplate 1, 2 are respectively embedded in the spacer 3.

The spacer 3 comprises a drill hole 5 for supporting a bearing unit 6 for the pedal axis 4, wherein the remaining material bar (a) approaches zero between the drill hole 5 and the outer surface of the spacer 3 in the area of the tread plate and the counterplate 1, 2, so that the force is almost directly transferred from the tread plate 1 to the bearing unit 6. The connection between the tread plate and the counterplate 1, 2 is created by connection elements 9, which are respectively arranged on both sides of the bearing unit 6. As a preferred connection, a screw connection is used, entailing countersunk head screws 9 which respectively grip in pairs into a thread bush from both sides, and which are arranged in drill holes in the spacer 3.

### LIST OF REFERENCE NUMERALS

1 Tread plate (counterplate)

2 Counterplate (tread plate)

3 Spacer

4 Pedal axis

5 Drill hole

6 Bearing unit

7 Inner bearing

8 Outer bearing

9 Connection elements incl. countersunk head screws

10 Groove-type recess in the outer covering of the bearing unit 6

11 Ring groove-type enlarged section of the drill hole 5

12 Snap ring or clip

13 Hollow area

14 Hollow area

15 Circumferential edge

16 Outer coating

17 Bearing bush

18 Bearing sheath

19 Opening

20 Snap ring

a Material of the spacer

1. A bicycle pedal consisting of a full-surface tread plate and a full-surface counterplate (1, 2), which are designed identically so that, depending on the position of the pedal, the tread plate (1) can also be the counterplate (2) and vice-versa,
wherein between the tread plate (1) and the counterplate (2), a spacer (3) is arranged which guarantees the distance between the tread plate and the counterplate (1, 2),
wherein the spacer (3) comprises a drill hole (5) for receiving a bearing unit (6) for the pedal axis (4),
wherein the material of the spacer remaining (a) between the drill hole (5) and the outer surface of the spacer (3) approaches zero in the area of the tread plate and of the counterplate (1, 2) so that force is almost directly transferred from the tread plate (1) to the bearing unit (6), and
wherein the connection between the tread plate and the counterplate (1, 2) is created by at least two connection elements (9) which are respectively arranged on both sides of the bearing unit (6) such that by the arrangement of connection elements in direct proximity to the bearing unit (6) the affixation of the bearing unit (6) is guaranteed.

2. (canceled)

3. The bicycle pedal according to claim 1, wherein the spacer (3) is formed from a solid material in the area of the drill hole (5) and the arrangement of the connection elements (9), and otherwise from bars which affix a circumferential edge (15) between the tread plate and the counterplate (1, 2).

4. The bicycle pedal according to claim 1, wherein the spacer (3) consists of laminated wood layers.

5. The bicycle pedal according to claim 1, wherein the spacer (3) has a rhomboid form.

6. (canceled)

7. The bicycle pedal according to claim 1, wherein the spacer (3) comprises a coating (16) on the outer circumference between the tread plate and the counterplate (1, 2).

8. The bicycle pedal according to claim 7, wherein the coating (16) also covers the outer narrow circumferential surfaces of the tread plate and the counterplate (1, 2), thus protecting them,

9. (canceled)

10. The bicycle pedal according to claim 1, wherein advertising is inserted into the openings of the hollow areas (13, 14) which is visible from outside, and/or the circumferential edge (15) and/or the coating (16) and/or the spacer (3) comprise advertising print which is directed outwards.

11. (canceled)

12. (canceled)

13. The bicycle pedal according to claim 1, wherein the bearing unit (6) consists of two bearings (7, 8) which are arranged on the pedal axis, of which one bearing (7) or (8) is supported in a bearing bush (17), wherein the bearing bush (17) is inserted into the drill hole (5) and affixed, while the other bearing (8) or (7) is directly supported in the drill hole (5).

14. (canceled)

15. The bicycle pedal according to claim 1, wherein the bearing unit (6) consists of a tribological pairing between the pedal axis (4) and a bearing sheath (18) which is pushed over the pedal axis (4), wherein the bearing sheath (18) is inserted into the drill hole (5) and affixed, and a bearing (7) or (8) which is supported in the drill hole (5).

16. The bicycle pedal according to claim 13, wherein the inner bearing (7) which is arranged closest to the bicycle frame on the pedal axis (4) is affixed in the bearing bush (17) or the bearing sheath (18), while the outer bearing (8) is arranged within the spacer (3) and is affixed by the connection between the tread plate and the counterplate (1, 2).

17. (canceled)

18. The bicycle pedal according to claim 1, wherein the pedal axis (4) tapers between the inner bearing (7) and the outer bearing (8).

19. The bicycle pedal according to claim 1, wherein the spacer (3) comprises an opening (19) in a section of the drill hole (5) which can be covered by the tread plate and the counterplate (1, 2), so that the inserted bearing unit (6) can be affixed in the opening (19) by means of a snap ring or clip (12).

20. The bicycle pedal according to claim 19, wherein the drill hole (5) comprises at least one ring groove-type enlarged section (11) and the bearing bush (17) or the bearing sheath (18) has at least one groove-type recess (10), of such a type that a snap ring (12) or clip which grips into the groove-type recess (10) simultaneously grips into the groove-type enlarged section (11), thus preventing a displacement of the pedal body on the pedal axis (4).

21. The bicycle pedal according to claim 19, wherein at least one of the tread plate or counterplate (1, 2) which are connected to each other acts on the snap ring or clip (12) so that the snap ring or clip (12) is affixed with no play in the connection between the bearing bush (17) and the spacer (3) or the bearing sheath (18) and the spacer (3).

22. The bicycle pedal according to claim 1, wherein the tread plate and the counterplate (1, 2) are made of stainless steel, magnesium, or aluminum, titanium or an alloy or a combination of these.
